(19) United States
(12) Patent Application Publication
(10) Pub. No.: US 2026/0034483 A1
(43) Pub. Date: Feb. 5, 2026

(54) SYSTEM AND METHOD FOR AUTOMATICALLY REPLACING CARTRIDGE FILTER

(71) Applicant: SAMSUNG SDI CO., LTD., Yongin-si (KR)

(72) Inventors: Hyomin SEO, Yongin-si (KR); Gayeong YUN, Yongin-si (KR); Jisu KIM, Yongin-si (KR); Minjun KIM, Yongin-si (KR)

(21) Appl. No.: 19/287,999

(22) Filed: Aug. 1, 2025

(30) Foreign Application Priority Data
Aug. 5, 2024 (KR) 10-2024-0104261

(51) Int. Cl. B01D 29/96; B01D 35/12; B01D 35/143

(52) U.S. Cl. CPC B01D 29/96; B01D 35/12; B01D 35/143

(57) ABSTRACT

A system for automatically replacing a cartridge filter includes a filter monitoring part configured to monitor a state of a filter that filters slurry, a filter area monitoring part configured to monitor a state of an area having a plurality of filters, and a filter command part configured to generate a command for filter replacement by considering the state of the filter and transmit the command to a driving part.

### CROSS-REFERENCE TO RELATED APPLICATION

The present application claims priority to and the benefit of Korean Patent Application No. 10-2024-0104261, filed on Aug. 5, 2024, in the Korean Intellectual Property Office, the entire disclosure of which is incorporated herein by reference.

### BACKGROUND

### 1. Field

The present disclosure relates to a system and method for automatically replacing a cartridge filter.

### 2. Description of the Related Art

Agglomerates or magnetic/non-magnetic metal within slurry, which has a negative effect on an electrode plate process and cell characteristics, is present in positive electrode and negative electrode slurry supply pipes. For the purpose of removing such alien substances, cartridge filters are installed in several sections and are usually replaced once a day.

The above information disclosed in this background section is only for enhancement of understanding of the background of the disclosure and therefore it may contain information that does not form the related art that is already known to a person of ordinary skill in the art.

### SUMMARY

Embodiments include a system for automatically replacing a cartridge filter, the system including a filter monitoring part configured to monitor a state of a filter that filters slurry, a filter area monitoring part configured to monitor a state of an area having a plurality of filters, and a filter command part configured to generate a command for filter replacement by considering the state of the filter and transmit the command to a driving part.

The filter monitoring part may be configured to monitor the state of the filter related to a plugging level of the filter by obtaining sensing values from a slurry entry monitoring part and a slurry exit monitoring part.

The filter monitoring part may be configured to obtain the sensing values from the slurry entry monitoring part, the slurry entry monitoring part including a digital pressure sensor.

The filter monitoring part may be configured to obtain the sensing values from the slurry exit monitoring part, the slurry exit monitoring part being a flux sensor.

The filter area monitoring part may be configured to monitor a preset state of a plurality of filter areas, and the plurality of filter areas are a revolver type.

The filter command part may be configured to transmit a driving signal to the driving part so that the driving part performs automatic filter replacement by rotating each of the plurality of filter areas if it is determined that a use-by date of the filter has expired or a filter plugging phenomenon is detected based on results of the monitoring.

The filter command part may be configured to generate the command for filter replacement by receiving results of the monitoring by the filter area monitoring part for the state of the plurality of filter areas including a slurry alien substance filtering area, a filter removal area, a remaining alien substance removal area, and a new filter mounting area.

The filter command part may be configured to generate the command for filter replacement so that a new filter closest to the slurry alien substance filtering area and in the new filter mounting area may be sequentially rotated, driven, and replaced in the slurry alien substance filtering area.

The filter command part may be configured to adjust a priority of application of a new filter in the slurry alien substance filtering area, by additionally considering information on different specifications of the plurality of filters.

Embodiments include a method of automatically replacing a cartridge filter by a system for automatically replacing a cartridge filter, the method including monitoring a slurry entry section and a slurry exit section, monitoring a filter area, and transmitting a filter replacement command based on results of monitoring the slurry entry section, the slurry exit section and the filter area.

Monitoring the slurry entry section and the slurry exit section may include monitoring a filter plugging level by receiving a sensing value from a digital pressure sensor in the slurry entry section and receiving a sensing value from a flux sensor in the slurry exit section.

Monitoring the filter area may include monitoring a preset state of a plurality of filter areas, and managing the plurality of filter areas as one of a slurry alien substance filtering area, a filter removal area, a remaining alien substance removal area, and a new filter mounting area.

Transmitting the filter replacement control command may include transmitting a rotation driving signal to perform automatic filter replacement by rotating the plurality of filter areas, each being a revolver type, when it is determined that a use-by date of a filter has expired or a filter plugging phenomenon is detected based on results of monitoring the slurry entry section, the slurry exit section and the preset state of the plurality of filter areas.

Transmitting the filter replacement control command may include transmitting the filter replacement command so that a new filter closest to the slurry alien substance filtering area and in the new filter mounting area may be sequentially rotated, driven, and replaced in the slurry alien substance filtering area.

Transmitting the filter replacement control command may include transmitting the filter replacement command to adjust a priority of application of a new filter in the slurry alien substance filtering area, by additionally considering information on different specifications of a plurality of filters.

Embodiments include an apparatus for automatically replacing a cartridge filter, the apparatus including an input interface device configured to obtain a sensing value related to a state of a filter, memory storing a program configured to determine a necessity of replacing a filter based on the sensing value and configured to transmit a filter replacement command stored in the memory, and a processor configured to execute the program, wherein the processor may be configured to transmit a driving signal to rotate a plurality of filter areas having a revolver type, by monitoring a state of an area having a plurality of filters.

The input interface device may be configured to obtain sensing values from a slurry entry monitoring part and a slurry exit monitoring part, and the processor may be configured to determine whether replacing a filter is necessary by analyzing a plugging level of the filter.

The processor may be configured to monitor a state of a slurry alien substance filtering area, a filter removal area, a remaining alien substance removal area, and a new filter mounting area, and control a replaced new filter to enter the slurry alien substance filtering area by transmitting the driving signal.

The processor may be configured to transmit the driving signal so that a new filter that is closest to the slurry alien substance filtering area and in the new filter mounting area is sequentially rotated, driven, and replaced in the slurry alien substance filtering area.

The processor may be configured to adjust a priority of application of the new filter in the slurry alien substance filtering area, by additionally considering information on different specifications of a plurality of filters.

### BRIEF DESCRIPTION OF THE DRAWINGS

Features will become apparent to those of ordinary skill in the art by describing in detail exemplary embodiments with reference to the attached drawings, in which:

FIG. 1 schematically illustrates an electrode assembly of a secondary battery;

FIG. 2 schematically illustrates a configuration of a pouch-type secondary battery;

FIG. 3 illustrates a schematic external appearance configuration of a prismatic secondary battery;

FIG. 4 is a cross-sectional view of a cylindrical secondary battery;

FIG. 5 illustrates a system for automatically replacing a cartridge filter according to embodiments of the present disclosure;

FIGS. 6 and 7 illustrate a process of automatically replacing a cartridge filter according to embodiments of the present disclosure;

FIG. 8 illustrates a method of automatically replacing a cartridge filter according to embodiments of the present disclosure;

FIG. 9 is a block diagram illustrating a computer system for implementing the method according to embodiments of the present disclosure;

FIG. 10 is an example view of a secondary battery module in which secondary batteries manufactured according to examples of the present disclosure are arranged;

FIG. 11 is an example view of a secondary battery pack including the secondary battery module illustrated in FIG. 10; and

FIG. 12 is a conceptual view of a vehicle including the secondary battery pack illustrated in FIG. 11.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in the present specification and claims are not to be limitedly interpreted based on their general or ordinary meaning, and should be interpreted as meanings and concepts that are consistent with the technical idea of the present disclosure on the basis of the principle that an inventor can be their own lexicographer to appropriately define concepts of terms to describe their disclosure in the best way.

The example embodiments described in this specification and the configurations shown in the drawings are only some example embodiments of the present disclosure and do not represent all of the aspects of the present disclosure. Accordingly, it should be understood that there may be various equivalents and modifications that can replace or modify one or more example embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges is within the scope of this disclosure.

References to two compared elements, features, etc. As being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

The terminology used herein is for the purpose of describing example embodiments of the present disclosure and is not intended to limit the present disclosure.

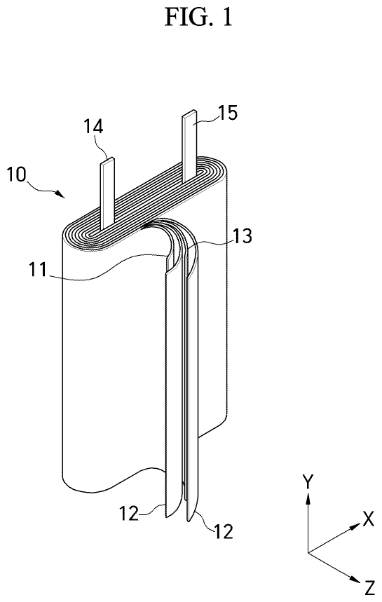

FIG. 1 schematically illustrates an electrode assembly built and being accommodated in a case of a secondary battery.

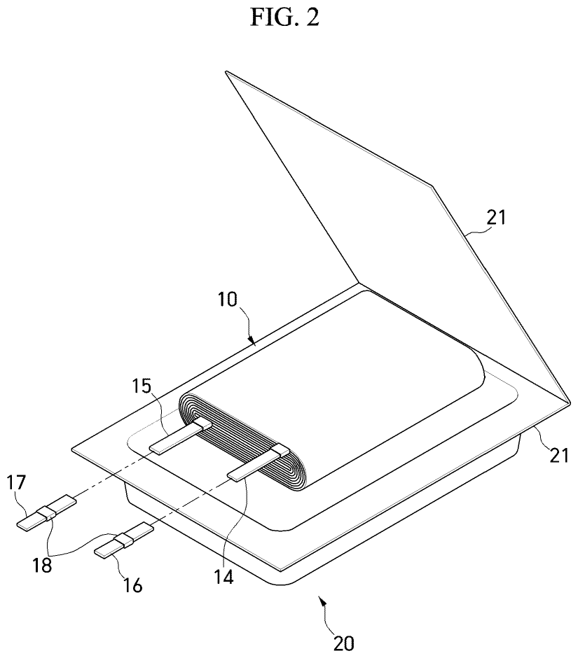

An electrode assembly 10 may be formed by winding or stacking a stack of a first electrode plate 11, a separator 12, and a second electrode plate 13, which are formed as thin plates or films. When the electrode assembly 10 is a wound stack, a winding axis may be parallel to the longitudinal direction (e.g., the Y-axis direction) of the case 20 (see FIG. 2). In other example embodiments, the electrode assembly 10 may be a stack type rather than a winding type, and the shape of the electrode assembly 10 may be or include a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case may vary. The first electrode plate 11 of the electrode assembly may act as a negative electrode, and the second electrode plate 13 may act as a positive electrode. In examples, the reverse is also possible.

The first electrode plate 11 may be formed by applying a first electrode active material, such as graphite or carbon, to a first electrode current collector formed of a metal foil, such as copper, a copper alloy, nickel, or a nickel alloy. The first electrode tab 14 may be connected to an external first terminal. In some example embodiments, when the first electrode plate 11 is manufactured, the first electrode tab 14 may be formed by being cut in advance to protrude to one side of the electrode assembly 10, or the first electrode tab 14 may protrude to one side of the electrode assembly 10 more than, e.g., farther than or beyond, the separator 12 without being separately cut.

The second electrode plate 13 may be formed by applying a second electrode active material, such as a transition metal oxide, on a second electrode current collector formed of or including a metal foil, such as aluminum or an aluminum alloy. The second electrode plate 13 may include a second electrode tab 15 (e.g., a second uncoated portion) that is or includes a region to which the second electrode active material is not applied. The second electrode tab 15 may be connected to an external second terminal. In some example embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than, e.g., farther than or beyond, the separator 12 without being separately cut.

In some example embodiments, the first electrode tab 14 may be located on the left side of the electrode assembly 10, and the second electrode tab 15 may be located on the right side of the electrode assembly 10. In other example embodiments, the first electrode tab 14 and the second electrode tab 15 may be located on one side of the electrode assembly 10 in the same direction.

Here, for convenience of description, the left and right sides are defined according to the electrode assembly 10 as oriented in FIG. 1, and the positions thereof may change when the secondary battery is rotated left and right or up and down.

The separator 12 hinders or substantially prevents a short-circuit between the first electrode plate 11 and the second electrode plate 13 while allowing movement of lithium ions therebetween. The separator 12 may be made of or include, for example, a polyethylene film, a polypropylene film, a polyethylene-polypropylene film, etc.

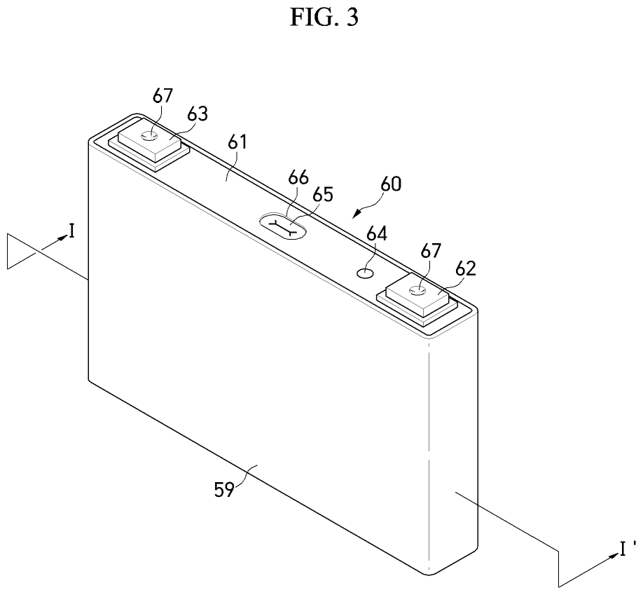

In some example embodiments, the electrode assembly 10 may be accommodated in a case (see FIG. 2) along with an electrolyte. In the case of a pouch-type secondary battery, an electrode assembly 10 may be accommodated in a pouch made of or including flexible material in the form illustrated in FIG. 2. In the case of a prismatic secondary battery, an electrode assembly 10 may be accommodated in a prismatic metal casing in the form illustrated in FIG. 3.

FIG. 2 schematically illustrates the pouch-type secondary battery.

The pouch-type secondary battery includes an electrode assembly 10 and a case 20 (in the form of a pouch) that accommodates or contains the electrode assembly 10 therein.

The electrode assembly 10 may be the same as the electrode assembly 10 illustrated in FIG. 1. The first electrode tab 14 and the second electrode tab 15 of the electrode assembly 10 may be electrically connected to respective external first terminal lead 16 and second terminal lead 17 by, e.g., welding or other attaching method that preserves conductivity therebetween. At least a portion of each of the first terminal lead 16 and the second terminal lead 17 may be attached or covered with a tab film 18 for insulation from the case 20 (in pouch form).

The case 20 (in pouch form) may be sealed by having sealing parts 21 at the edges thereof come into contact with each other while accommodating or containing the electrode assembly 10 therein, in which case the sealing may be achieved with the tab film 18 interposed between the sealing parts 21. The sealing parts 21 of the case 20 (in pouch form) may be made of or include a thermal fusion material that generally has weak adhesion to metal. Thus, it may be fused to the case 20 (in pouch form) by interposing the tab film 18 that is thin between the sealing parts 21.

FIG. 3 illustrates a schematic external appearance configuration of a prismatic secondary battery.

A prismatic case 59 defines an overall appearance of the prismatic secondary battery, and may be made of or include a conductive metal, such as aluminum, aluminum alloy, or nickel-plated steel. In addition, the prismatic case 59 may provide a space for accommodating or containing the electrode assembly 10 therein.

A cap assembly 60 may include a cap plate 61 that covers an opening of the prismatic case 59, and the prismatic case 59 and the cap plate 61 may be made of or include a conductive material. A first terminal 63 and a second terminal 62 may be electrically connected to the first electrode tab 14 and the second electrode tab 15, respectively, of the electrode assembly 10 illustrated in FIGS. 1 and 2 inside the prismatic case 59, and may be installed to protrude outward through the cap plate 61.

The cap plate 61 may be equipped with or include an electrolyte injection port 64 configured to install a sealing plug therein, and a vent 66 formed that includes a notch 65 may be installed. The vent 66 is configured to discharge any gas generated inside the secondary battery.

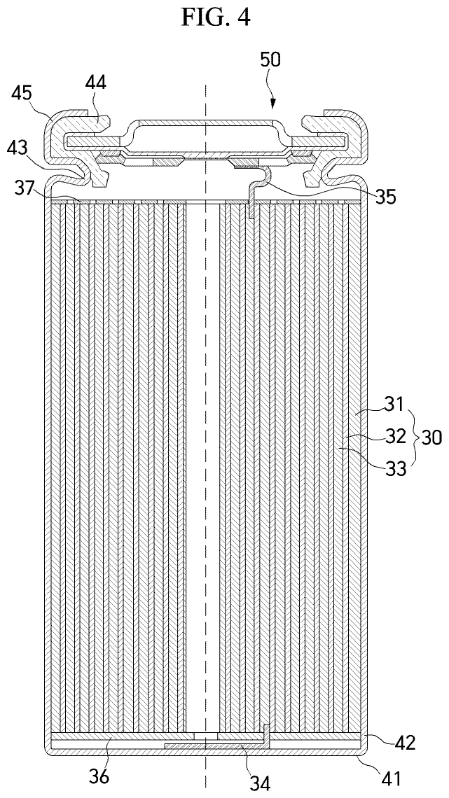

FIG. 4 is a cross-sectional view of a cylindrical secondary battery.

The cylindrical secondary battery includes an electrode assembly 30, a case accommodating the electrode assembly 30 and an electrolyte therein, a cap assembly 50 coupled to an opening of the case to seal the case, and an insulating plate 37 located between the electrode assembly 30 and the cap assembly 50 inside the case.

The electrode assembly 30 may include a separator 32 between a first electrode 33 and a second electrode 31, and the electrode assembly 30 may be wound in a jelly-roll form.

The first electrode 33 may include a first substrate and a first active material layer located on the first substrate. A first lead tab 35 may extend outward from a first uncoated portion of the first substrate where the first active material layer is not located, and may be electrically connected to the cap assembly 50.

The second electrode 31 may include a second substrate and a second active material layer located on the second substrate. A second lead tab 34 may extend outward from a second uncoated portion of the second substrate where the second active material layer is not located, and may be electrically connected to the case. The first lead tab 35 and the second lead tab 34 may extend in opposite directions with respect to each other.

The first electrode 33 may constitute a positive electrode. In this case, the first substrate may be composed of or include, for example, aluminum foil, and the first active material layer may include, for example, a transition metal oxide. The second electrode 31 may constitute a negative electrode. In this case, the second substrate may be composed of or include, for example, copper foil or nickel foil, and the second active material layer may include, for example, graphite.

The separator 32 may reduce or prevent a short-circuit between the first electrode 33 and the second electrode 31 while allowing movement of lithium ions therebetween. The separator 32 may be made of or include, for example, at least one of a polyethylene film, a polypropylene film, a polyethylene-polypropylene film, etc.

The case accommodates or contains the electrode assembly 30 and the electrolyte, and substantially forms the external appearance of the secondary battery together with the cap assembly 50. The case may have a substantially cylindrical body portion 42, and a bottom portion 41 connected to one side of the cylindrical body portion 42. A beading part 43 deformed inwardly may be formed in the cylindrical body portion 42, and a crimping part 45 bent inwardly may be formed at an open end of the cylindrical body portion 42.

The beading part 43 may reduce or prevent movement of the electrode assembly 30 inside the case, and may facilitate seating of a gasket 44 and the cap assembly 50. A crimping part 45 may firmly fix the cap assembly 50 by pressing the edge of the cap assembly 50 against the gasket 44. The case may be formed of or include iron plated with nickel, for example.

The cap assembly 50 may be fixed to the inside of the crimping part 45 through the gasket 44 to seal the case. The cap assembly 50 may include a cap up, a safety vent, a cap down, an insulating member, and a subplate, but may be variously modified.

The cap up may be located at the very top of the cap assembly 50. The cap up may include a terminal portion that protrudes convexly upward and is connected to an external circuit, and an outlet for discharging gas may be located around the terminal portion.

The safety vent may be located below the cap up. The safety vent may include a protrusion that protrudes convexly downward and is connected to the subplate, and at least one notch located around the protrusion.

When gas is generated due to overcharging or abnormal operation of the secondary battery, the protrusion may be deformed upward by pressure and may separate from the subplate, while the safety vent may be cut along the notch. The cut safety vent may hinder or prevent the secondary battery from exploding by discharging gas to the outside.

The cap down may be located below the safety vent. The cap down may be formed with a first opening for exposing the protrusion of the safety vent and a second opening for discharging gas. The insulating member may be located between the safety vent and the cap down to insulate the safety vent and the cap down.

The subplate may be located below the cap down. The subplate may be fixed to a lower surface of the cap down to block the first opening of the cap down, and the protrusion of the safety vent may be fixed to the subplate. The first lead tab 35 pulled out from the electrode assembly 30 may be fixed to the subplate. Accordingly, the cap up, the safety vent, the cap down, and the subplate may be electrically connected to the first electrode 33 of the electrode assembly 30.

The insulating plate 37 may be located below the beading part 43 to be in contact with the electrode assembly 30, and may be provided with a tab opening for pulling out the first lead tab 35. The cap assembly 50, which is electrically connected to the first electrode 33 by the first lead tab 35, may face the electrode assembly 30 with the insulating plate 37 interposed therebetween, and may maintain an insulated state from the electrode assembly 30 by the insulating plate 37. On the other hand, another insulating plate 36 may be included for insulation between the electrode assembly 30 and the bottom portion 41 of the case.

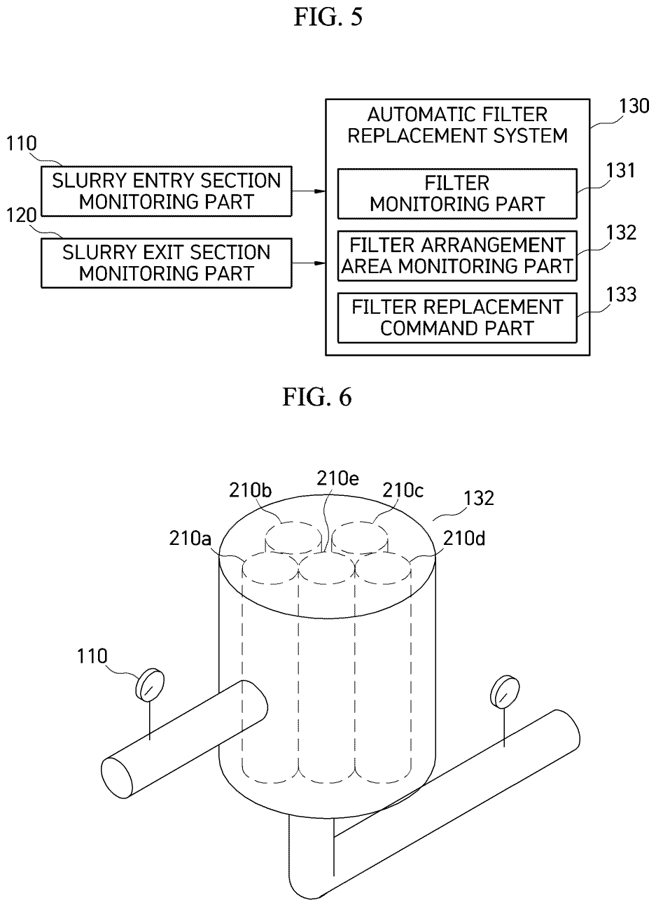

Hereinafter, a system and method for automatically replacing a cartridge filter according to embodiments of the present disclosure are described with reference to FIGS. 5 to 9.

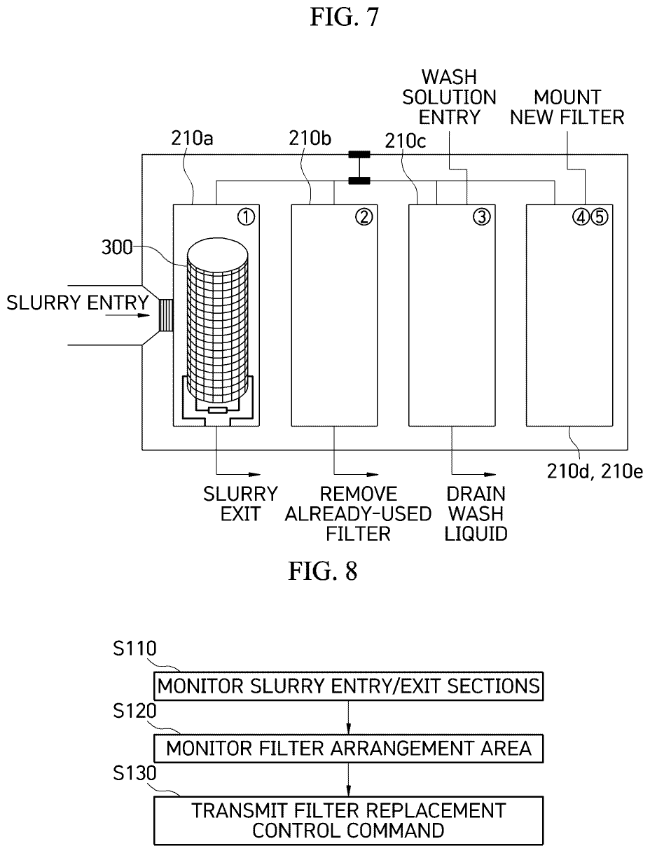

FIG. 5 illustrates a system for automatically replacing a cartridge filter according to embodiments of the present disclosure. FIGS. 6 and 7 illustrate a process of automatically replacing a cartridge filter according to embodiments of the present disclosure.

A system 130 for automatically replacing a cartridge filter (or an automatic filter replacement system) according to embodiments of the present disclosure may include a filter monitoring part 131 that monitors the state of a filter, a filter arrangement area monitoring part 132 (e.g., a filter area monitoring part) that monitors the state of an area in which a plurality of filters has been disposed, and a filter replacement command part 133 (e.g., a filter command part) that generates a command for filter replacement by considering the state of a filter and transmits the command to a driving part.

The filter monitoring part 131 may monitor the state of a filter related to the plugging level of the filter (e.g., filter plugging level refers to the extent to which a filter is blocked or restricted by accumulated contaminants) by obtaining sensing values from a slurry entry section monitoring part 110 (e.g., a slurry entry monitoring part) and a slurry exit section monitoring part 120 (e.g., a slurry exit monitoring part).

The filter monitoring part 131 may confirm the state of a filter by monitoring slurry supply and discharge-related data of slurry entry and exit sections.

The slurry entry section monitoring part 110 may be disposed as a digital pressure sensor, and may monitor pressure data of the slurry entry section.

The slurry exit section monitoring part 120 may be disposed as a flux sensor, and may monitor flux data of the slurry exit section.

The filter arrangement area monitoring part 132 may monitor the preset state of a plurality of filter arrangement areas, including a first area 210a, a second area 210b, a third area 210c, and a fourth area 210d and 210e (see FIG. 6).

The filter arrangement area monitoring part 132 may manage the first area 210a as a slurry alien substance filtering area, the second area 210b as a filter removal area, the third area 210c as the remaining alien substance removal area, and the fourth area 210d and 210e as a new filter mounting area, with respect to the plurality of filter arrangement areas that is disposed in a revolver type (e.g., the filter arrangement area monitoring part 132 may loosely resemble a cylinder of a revolver and have the first through fourth areas arranged adjacent to each other inside a cylindrical structure).

Slurry may be supplied from the first area 210a. Alien substances may be filtered out by a filter 300 (see FIG. 7) that has been installed.

When it is determined that the use-by date of a filter has expired or a phenomenon in which a filter has been plugged is detected based on the results of the monitoring of the filter monitoring part 131, the filter arrangement area monitoring part 132 may transmit a command generation request (e.g., a signal) to the filter replacement command part 133 by considering the state monitoring results of a filter arrangement area.

The filter replacement command part 133 may control the driving part that performs automatic filter replacement by automatically rotating the plurality of filter arrangement areas having the revolver type, by transmitting a driving signal to the driving part, so that the filter 300 that is already used is transmitted to the second area 210b and a new filter disposed in the area 210e of the fourth area 210d and 210e disposed in the first area 210a.

The existing filter may be removed after being moved to the second area 210b. A washing solution may enter the filter arrangement areas in the third area 210c, and a wash liquid may be discharged from the third area 210c.

Anew filter may be mounted on the fourth area 210d and 210e. As the driving part is subsequently rotated by receiving the driving signal of the filter replacement command part 133, the new filter may be disposed in the first area 210a, that is, the slurry alien substance filtering area.

The filter replacement command part 133 may basically perform a function for controlling the driving part so that new filters are sequentially disposed in the first area 210a by controlling the driving part so that the closest new filter of the first area 210a in the fourth area 210d and 210e is rotated and driven in the revolver type and a corresponding already-used filter is removed by transferring the corresponding filter to the second area 210b based on the expiration of the use-by date of the corresponding filter or the results of the detection of a filter plugging phenomenon (e.g., the filter plugging phenomenon is detected).

In another embodiment, the filter replacement command part 133 may replace a corresponding filter with a filter having different specifications by determining a filter plugging level of the corresponding filter through feedback control using the results of the monitoring of the digital pressure sensor and the flux sensor. For example, if a filter disposed in a next priority area (210d of the fourth area), not the area 210e that belongs to the fourth area 210d and 210e and that is closest to the first area 210a, has suitable specifications corresponding to current monitoring results, the filter replacement command part 133 may generate a control command for the driving part so that a new filter disposed in the next priority area 210d, not a new filter disposed in the closest area 210e, is disposed in the first area 210a. Next, the filter replacement command part 133 may generate a control command for the driving part so that the existing closest filter instead of a filter the use of which has been completed is disposed in the first area 210a by reversely rotating and driving the driving part, or may generate a control command for the driving part so that a filter that has been disposed in the existing next priority area and used is replaced with a new filter having the specifications of the filter that has been disposed in the existing next priority area and used.

In order to help understanding of those skilled in the art, it is assumed that the existing filter mounted in the first area 210a of FIG. 6 is a first filter and new filters mounted in the fourth area 210d and 210e (i.e., both 210d and 210e are together the fourth area) are a second filter and a third filter. When it is determined that the second filter not the third filter needs to be mounted as comprehensive consideration results of monitoring and filter specifications, the filter replacement command part 140 may generate a control command for the driving part so that the second filter not the third filter that is closest to the first area 210a is preferentially disposed in the first area 210a. As the second filter is disposed in the first area 210a, the third filter is disposed in the second area 210b in an unused state. The filter replacement command part 133 may perform replacement stop control so that the third filter that has not been used is not replaced by transmitting a separate control signal to filter replacement means (e.g., filter replacement machinery).

Next, when the use-by date of the second filter expires or a filter plugging phenomenon occurs, the filter replacement command part 133 may control the backward driving of the driving part so that the third filter is disposed in the first area 210a. Accordingly, the second filter that has already been used may be disposed in area 210e of the fourth area 210d and 210e. The filter replacement command part 133 may perform lead-in stop control so that a new filter does not enter an area in which the second filter that has been already used has been mounted, by transmitting a separate control signal to new filter lead-in means (e.g., new filter lead-in machinery).

Thereafter, the filter replacement command part 133 may control the driving part so that the second filter and the third filter are sequentially removed through the second area 210b and filter replacement is automatically performed through washing in the third area 210c and the mounting of new filters in the fourth area 210d and 210e.

That is, the filter replacement command part 133 may generate a control command for forward driving and backward driving for the rotation driving in the revolver type by performing feedback control using monitoring results.

FIG. 8 illustrates a method of automatically replacing a cartridge filter according to embodiments of the present disclosure.

The method of automatically replacing a cartridge filter according to embodiments of the present disclosure may include step S110 of performing monitoring on the slurry entry and exit sections, step S120 of performing monitoring on the filter arrangement area, and step S130 of transmitting a filter replacement control command based on monitoring results (i.e., the monitoring results of step S110 and step S120).

In step S110, monitoring may be performed on a filter plugging level by receiving a sensing value from the digital pressure sensor disposed in the slurry entry section and receiving a sensing value from the flux sensor disposed in the slurry exit section.

In step S120, the preset state of the plurality of filter arrangement areas, including first area 210a, second area 210b, third area 210c, and fourth area 210d and 210e may be monitored. The first area 210a may be managed as the slurry alien substance filtering area, the second area 210b may be managed as the filter removal area, the third area 210c may be managed as the remaining alien substance removal area, and the fourth area 210d and 210e may be managed as the new filter mounting area, with respect to the plurality of filter arrangement areas disposed in the revolver type.

In step S130, when it is determined that the use-by date of a filter has expired or a filter plugging phenomenon is detected based on the results of the monitoring, a driving signal may be transmitted to the driving part that performs automatic filter replacement by automatically rotating the plurality of filter arrangement areas having the revolver type.

In step S130, the driving part may be controlled so that a filter that is already used is moved to the second area 210b and a new filter disposed in the fourth area 210d and 210e is disposed in the first area.

In response to a filter replacement control command transmitted in step S130, the existing filter may be moved to the second area 210b and then removed. Next, with respect to an area in which a corresponding filter has been mounted, the remaining alien substances may be removed from the third area 210c, and new filters may be mounted in the fourth area 210d and 210e.

As the filter replacement control command is transmitted in step S130, the driving part may be controlled so that new filters disposed in the fourth area are sequentially disposed in the first area.

As another example, in step S130, a filter that belongs to new filters disposed in the fourth area and that will be preferentially disposed in the first area may be determined by comprehensively considering the results of the monitoring of the slurry entry and exit sections and information on the specifications of a filter disposed to have different specifications. For example, if a filter disposed in a next priority area (e.g., 210d), not the area 210e that belongs to the fourth area 210d and 210e and that is closest to the first area 210a, has suitable specifications corresponding to current monitoring results, a control command for the driving part may be generated so that a new filter disposed in the next priority area (e.g., 210d), not a new filter disposed in the closest area 210e, is disposed in the first area 210a.

In step S130, the driving part may be controlled so that a new filter disposed in a next priority area continues to be used until the use-by date of the new filter expires or a filter plugging phenomenon is detected. The driving part may be controlled to temporarily stop the use of a corresponding new filter based on monitoring results and to dispose a new filter (i.e., a filter having relatively low specifications) of the existing closest area in the first area 210a and to filter out alien substance.

Next, a filter replacement control command may be transmitted so that alien substances are filtered out (i.e., so that each already-used filter can be recycled and used) while replacing the already-used filter until the use-by date of the already-used filter expires or a filter plugging phenomenon is detected.

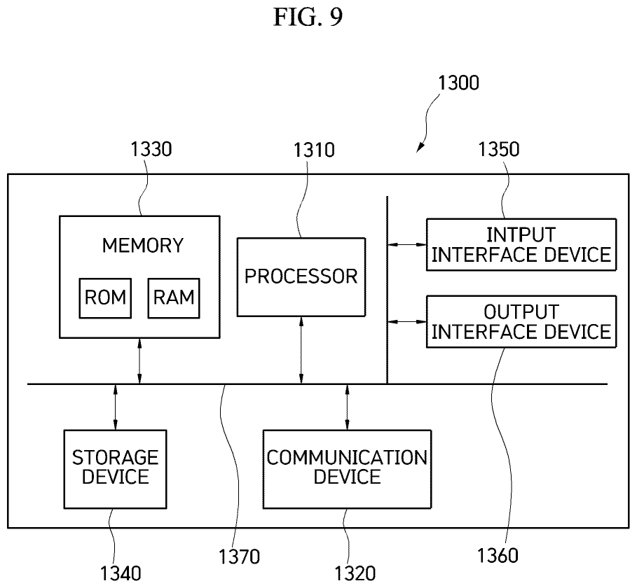

FIG. 9 is a block diagram illustrating a computer system for implementing a method according to an example embodiment of the present disclosure.

Referring to FIG. 9, the computer system 1300 may include at least one of a processor 1310, a memory 1330, an input interface device 1350, an output interface device 1360, and a storage device 1340 communicating with one another through a bus 1370. The computer system 1300 may also include a communication device 1320 coupled to a network. The processor 1310 may be or include a central processing unit (CPU) or a semiconductor device that executes instructions stored in the memory 1330 or in the storage device 1340. The memory 1330 and the storage device 1340 may include various types of volatile or nonvolatile storage media. For example, the memory may include a read-only memory (ROM) and a random access memory (RAM). In example embodiments of the present disclosure, the memory may be located inside or outside the processor, and may be connected to the processor through various known means. The memory is or includes various types of volatile or nonvolatile storage media, and for example, may include a read-only memory (ROM) or a random access memory (RAM).

An apparatus for automatically replacing a cartridge filter according to embodiments of the present disclosure may include an input interface device 1350 that obtains a sensing value related to the state of a filter, memory 1330 in which a program that determines whether it is necessary to replace a filter based on the sensing value and that transmits a filter replacement command has been stored, and a processor 1310 that executes the program. The processor 1310 may transmit a driving signal so that the plurality of filter arrangement areas having the revolver type is rotated, by monitoring the state of the area in which the plurality of filters has been disposed.

The input interface device 1350 may obtain sensing values from the slurry entry section monitoring part and the slurry exit section monitoring part. The processor 1310 may determine whether it is necessary to replace a filter by analyzing the plugging level of a filter.

The processor 1310 may monitor the state of areas including the slurry alien substance filtering area, the filter removal area, the remaining alien substance removal area, and the new filter mounting area, and may control the driving part so that a replaced new filter enters the slurry alien substance filtering area by transmitting a driving signal.

The processor 1310 may transmit a driving signal so that a new filter that is closest to the slurry alien substance filtering area and that is disposed in the new filter mounting area is sequentially rotated, driven, and disposed in the slurry alien substance filtering area.

The processor 1310 may adjust the priority of application of a new filter that is disposed in the slurry alien substance filtering area by additionally considering information on different specifications of a plurality of filters.

Accordingly, example embodiments of the present disclosure may be implemented as a method implemented in a computer or a non-transitory computer-readable medium storing computer-executable instructions. In an example embodiment, when executed by the processor, computer-readable instructions may perform a method according to at least one aspect (e.g., at least one embodiment) of the present disclosure.

The communication device 1320 may transmit or receive wired signals or wireless signals.

Additionally, the method according to an example embodiment of the present disclosure may be implemented in the form of program instructions that can be executed through various computer means and recorded (e.g., or stored) on a computer-readable medium.

The computer-readable medium may include program instructions, data files, data structures, etc., singly or in combination. The program instructions recorded on the computer-readable medium may be specially designed and configured for the example embodiments of the present disclosure, or may be known and usable by those of ordinary skill in the art of computer software. Computer-readable recording media may include a hardware device configured to store and perform program instructions. For example, the computer-readable recording media may be or include magnetic media such as hard disks, floppy disks, and magnetic tapes, optical media such as CD-ROMs and DVDs, magneto-optical media such as floptical disks, ROM, RAM, flash memory, etc. The program instructions may include not only machine language codes such as that generated by a compiler, but also high-level language codes that can be executed by a computer through an interpreter, etc.

Hereinafter, any material that may be usable for the secondary battery according to examples of the present disclosure will be described.

As the positive electrode active material, a compound capable of reversibly intercalating/deintercalating lithium (e.g., a lithiated intercalation compound) may be used. For example, at least one of a composite oxide of lithium and a metal such as at least one of cobalt, manganese, nickel, and combinations thereof may be used.

The composite oxide may be or include a lithium transition metal composite oxide, and examples thereof may include at least one of a lithium nickel oxide, a lithium cobalt oxide, a lithium manganese oxide, a lithium iron phosphate compound, a cobalt-free nickel-manganese oxide, or a combination thereof.

As an example, a compound represented by at least any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is or includes at least Ni, Co, Mn, or a combination thereof; X is or includes at least Al, Ni, Co, Mn, Cr, Fe, Mg, Sr, V, a rare earth element, or a combination thereof; D is or includes at least O, F, S, P, or a combination thereof; G is or includes at least Al, Cr, Mn, Fe, Mg, La, Ce, Sr, V, or a combination thereof; and L1 is or includes at least Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be or include aluminum (Al), but the material of the current collector may vary.

The negative electrode active material may include a material capable of reversibly intercalating/deintercalating at least one of lithium ions, lithium metal, an alloy of lithium metal, a material capable of being doped and undoped with lithium, or a transition metal oxide.

The material capable of reversibly intercalating/deintercalating lithium ions may be or include a carbon negative electrode active material, which may include, for example, at least crystalline carbon, amorphous carbon, or a combination thereof. Examples of the crystalline carbon may include graphite, such as natural graphite or artificial graphite, and examples of the amorphous carbon may include at least one of soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be or include at least silicon, a silicon-carbon composite, SiOx (0<x<2), a Si alloy, or a combination thereof.

The silicon-carbon composite may be or include a composite of silicon and amorphous carbon. According to one example embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode current collector, at least one of copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent may constitute a medium through which ions involved in the electrochemical reaction of the battery can move.

The non-aqueous organic solvent may be or include at least a carbonate, an ester, an ether, a ketone, an alcohol solvent, an aprotic solvent, and may be used alone or in combination of two or more.

Depending on the type of lithium secondary battery, a separator may be present between the first electrode plate (e.g., the negative electrode) and the second electrode plate (e.g., the positive electrode). As the separator, at least polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles such as at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but may vary.

The organic material and the inorganic material may be mixed in one coating layer or may be in the form of a coating layer containing an organic material and a coating layer containing an inorganic material that are laminated on each other.

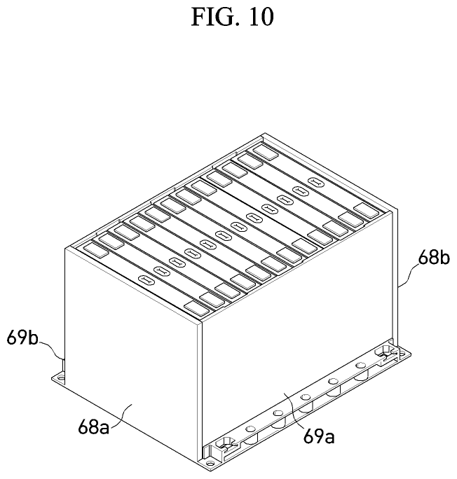

FIG. 10 is an illustration of a secondary battery module in which secondary batteries manufactured according to examples of the present disclosure are arranged. With the increase in secondary battery capacity for driving electric vehicles, and the like, a secondary battery module may be manufactured by arranging and connecting a plurality of secondary battery cells transversely and/or longitudinally. The plurality of secondary batteries may be arranged in a space defined by a pair of facing end plates 68a and 68b and a pair of facing side plates 69a and 69b. The secondary batteries may be designed appropriately in arrangement (direction) and number to obtain desired voltage and current specifications.

FIG. 11 is an illustration schematically showing the configuration of a battery pack 70 according to example embodiments of the present disclosure. Referring to FIG. 11, a battery pack 70 may include an assembly to which individual batteries are electrically connected, and a pack housing accommodating the same. In the drawings, for convenience of illustration, components including a bus bar, a cooling unit, external terminals for electrically connecting batteries, etc., are omitted.

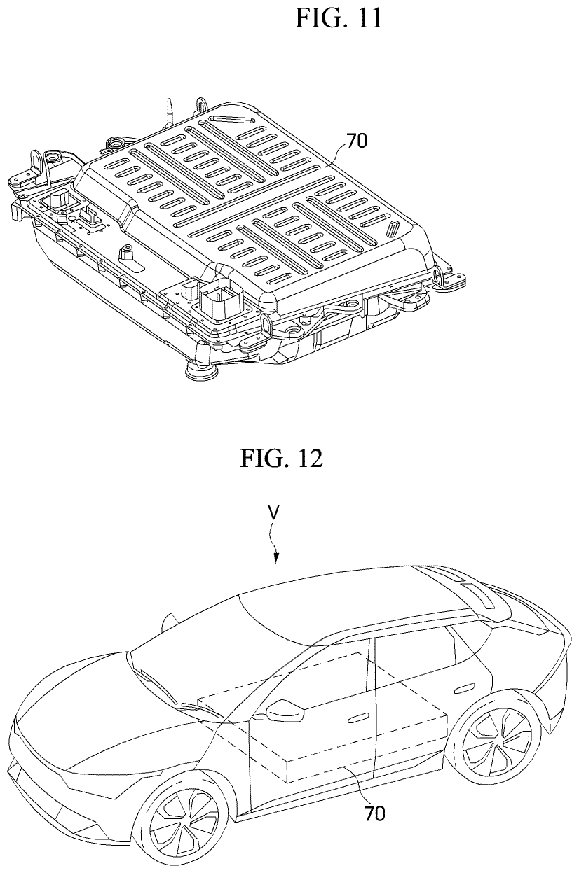

The battery pack 70 may be mounted on (or in) a vehicle. The vehicle may be, for example, an electric vehicle, a hybrid vehicle, a plug-in hybrid vehicle, and the like. The vehicle may be a four-wheeled vehicle or a two-wheeled vehicle but is not limited thereto. FIG. 12 shows a vehicle V which includes the battery pack 70 shown in FIG. 11 on the lower body thereof. The vehicle V may operate by (e.g., may be powered by) receiving power from the battery pack 70.

Embodiments provide a system and method for automatically replacing a cartridge filter, which do not stop a production line and can significantly reduce a work load by automatically replacing a cartridge filter although a worker does not directly replace a cartridge filter.

According to the present disclosure, it has the effect of significantly reducing the workload by providing an automatic filter replacement function for the device, without requiring a worker to individually stop the slurry supply, disassemble the housing, replace it with a new filter, and reassemble the housing.

Although the present disclosure has been described above with respect to example embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A system for automatically replacing a cartridge filter, the system comprising:
a filter monitoring part configured to monitor a state of a filter that filters slurry;
a filter area monitoring part configured to monitor a state of an area having a plurality of filters; and
a filter command part configured to generate a command for filter replacement by considering the state of the filter and transmit the command to a driving part.

2. The system as claimed in claim 1, wherein the filter monitoring part is configured to monitor the state of the filter related to a plugging level of the filter by obtaining sensing values from a slurry entry monitoring part and a slurry exit monitoring part.

3. The system as claimed in claim 2, wherein the filter monitoring part is configured to obtain the sensing values from the slurry entry monitoring part, the slurry entry monitoring part including a digital pressure sensor.

4. The system as claimed in claim 2, wherein the filter monitoring part is configured to obtain the sensing values from the slurry exit monitoring part, the slurry exit monitoring part being a flux sensor.

5. The system as claimed in claim 1, wherein:
the filter area monitoring part is configured to monitor a preset state of a plurality of filter areas, and
the plurality of filter areas are a revolver type.

6. The system as claimed in claim 5, wherein the filter command part is configured to transmit a driving signal to the driving part so that the driving part performs automatic filter replacement by rotating the plurality of filter areas if it is determined that a use-by date of the filter has expired or a filter plugging phenomenon is detected based on results of the monitoring.

7. The system as claimed in claim 5, wherein the filter command part is configured to generate the command for filter replacement by receiving results of the monitoring by the filter area monitoring part for the state of the plurality of filter areas comprising a slurry alien substance filtering area, a filter removal area, a remaining alien substance removal area, and a new filter mounting area.

8. The system as claimed in claim 7, wherein the filter command part is configured to generate the command for filter replacement so that a new filter closest to the slurry alien substance filtering area and in the new filter mounting area is sequentially rotated, driven, and replaced in the slurry alien substance filtering area.

9. The system as claimed in claim 7, wherein the filter command part is configured to adjust a priority of application of a new filter in the slurry alien substance filtering area, by additionally considering information on different specifications of the plurality of filters.

10. A method of automatically replacing a cartridge filter by a system for automatically replacing a cartridge filter, the method comprising:
monitoring a slurry entry section and a slurry exit section;
monitoring a filter area; and
transmitting a filter replacement command based on results of monitoring the slurry entry section, the slurry exit section and the filter area.

11. The method as claimed in claim 10, wherein monitoring the slurry entry section and the slurry exit section comprises monitoring a filter plugging level by receiving a sensing value from a digital pressure sensor in the slurry entry section and receiving a sensing value from a flux sensor in the slurry exit section.

12. The method as claimed in claim 10, wherein monitoring the filter area comprises:
monitoring a preset state of a plurality of filter areas, and
managing the plurality of filter areas as one of a slurry alien substance filtering area, a filter removal area, a remaining alien substance removal area, and a new filter mounting area.

13. The method as claimed in claim 12, wherein transmitting the filter replacement control command comprises transmitting a rotation driving signal to perform automatic filter replacement by rotating the plurality of filter areas, together being a revolver type, when it is determined that a use-by date of a filter has expired or a filter plugging phenomenon is detected based on results of monitoring the slurry entry section, the slurry exit section and the preset state of the plurality of filter areas.

14. The method as claimed in claim 13, wherein transmitting the filter replacement control command comprises transmitting the filter replacement command so that a new filter closest to the slurry alien substance filtering area and in the new filter mounting area is sequentially rotated, driven, and replaced in the slurry alien substance filtering area.

15. The method as claimed in claim 13, wherein transmitting the filter replacement control command comprises transmitting the filter replacement command to adjust a priority of application of a new filter in the slurry alien substance filtering area, by additionally considering information on different specifications of a plurality of filters.

16. An apparatus for automatically replacing a cartridge filter, the apparatus comprising:
an input interface device configured to obtain a sensing value related to a state of a filter;
memory storing a program configured to determine a necessity of replacing a filter based on the sensing value and configured to transmit a filter replacement command stored in the memory; and
a processor configured to execute the program,
wherein the processor is configured to transmit a driving signal to rotate a plurality of filter areas having a revolver type, by monitoring a state of an area having a plurality of filters.

17. The apparatus as claimed in claim 16, wherein:
the input interface device is configured to obtain sensing values from a slurry entry monitoring part and a slurry exit monitoring part, and
the processor is configured to determine whether replacing a filter is necessary by analyzing a plugging level of the filter.

18. The apparatus as claimed in claim 16, wherein the processor is configured to:
monitor a state of a slurry alien substance filtering area, a filter removal area, a remaining alien substance removal area, and a new filter mounting area, and
control a replaced new filter to enter the slurry alien substance filtering area by transmitting the driving signal.

19. The apparatus as claimed in claim 18, wherein the processor is configured to transmit the driving signal so that a new filter that is closest to the slurry alien substance filtering area and in the new filter mounting area is sequentially rotated, driven, and replaced in the slurry alien substance filtering area.

20. The apparatus as claimed in claim 18, wherein the processor is configured to adjust a priority of application of the new filter in the slurry alien substance filtering area, by additionally considering information on different specifications of a plurality of filters.
